(19) United States
(12) Patent Application Publication
(10) Pub. No.: US 2026/0293798 A1
(43) Pub. Date: Oct. 1, 2026

(54) PROCESSOR CONTROL OVER THE STATE (POSITION, ATTITUDE OR DEGREE OF OPENNESS) OF DISCHARGE GATES FOR MOWERS

(71) Applicants: Gregory M. Bond, Ozark, MO (US); Matthew L. Thomas, Springfield, MO (US); David A. Thomas, Ozark, MO (US)

(72) Inventors: Gregory M. Bond, Ozark, MO (US); Matthew L. Thomas, Springfield, MO (US); David A. Thomas, Ozark, MO (US)

(21) Appl. No.: 19/710,808

(22) Filed: Jun. 17, 2026

Related U.S. Application Data
(63) Continuation-in-part of application No. 19/459,442, filed on Jan. 26, 2026.
Application No. 19/459,442 is a continuation-in-part of application No. 18/588,561, filed on Feb. 27, 2024, now Pat. No. 12,532,804.
(60) Provisional application No. 63/487,022, filed on Feb. 27, 2023.

(51) Int. Cl. A01D 34/00; A01D 34/71

(52) U.S. Cl. CPC A01D 34/006; A01D 34/71

(57) ABSTRACT

The present disclosure is directed to processor control over the state (position, attitude or degree of openness) of discharge gates for mowers and provides an electronics package which senses the position of the discharge gate and provides users fine control thereover A user input control having a user adjustable gate position sensor receives a user selected target angle for the discharge gate. A microprocessor operatively connected to the adjustable gate position sensor generates a motor control output to move the discharge gate to an angle associated with the user selected target angle.

### CROSS REFERENCE

The present application is a continuation-in part of U.S. patent application Ser. No. 19/459,442 having a filing date of Jan. 26, 2026, which is a continuation-in-part of U.S. patent application Ser. No. 18/588,561 having a filing date of Feb. 27, 2024 and issuing as U.S. Pat. No. 12,532,804, which claims the benefit of the filing date of U.S. Provisional Application No. 63/487,022 having a filing date of Feb. 27, 2023. The entire contents of the foregoing applications are incorporated herein by reference.

### BACKGROUND

The present disclosure relates to mowers and, more particularly, to control by means of electronic circuits, devices and processor for the “state” of a discharge gate for mowers. That is, “state” corresponds to position or degree of openness of the discharge gate (as in without limitation angle of attitude of a swinging flap-style discharge gate). Presumptively, the mower has a mowing deck with one or more discharge outlets for discharge of mown material (the outlets can be in any direction sideways, rear, etc.) In various mowers, a discharge gate is used to selectively cover and open the discharge outlet.

The two most common discharge gate controls known to date are: 1) manual control with either a foot or hand control, and 2) electric motor control. With manual control, the user has relatively good control of the position of the discharge gate. For instance, a manual bump on a cable-pushing and -pulling pedal or lever will open, close or otherwise position the discharge gate to approximately the position (“state” or “attitude”) as needed. One issue with a manual gate occurs as the gate wears and accumulates dirt on the moving parts requiring extended maintenance. Control cables can get pinched or jammed. Another issue is accuracy, as in when at an original time the user chooses to change from a first state to a second state, but then at a later time wanting to return to that first state, exactly.

With electric motor control known to date, a user is provided a switching option which has a zero option and one other option. And these produce three different outcomes:
the ‘zero option’ which corresponds to doing nothing (i.e., power OFF),
one toggle option in an indeterminate series of such toggle options corresponding to the discharge gate going from being open, as in straight up, to being closed, as in straight down, or vice versa,
a succeeding another exercise of the one toggle option which results in the reverse of the above,
a further succeeding exercise of the one toggle option corresponding to the reverse again, and so on.

Electric motor discharge gate control is similar to an electric window on a car door where the two easily obtained possibilities are for the window to be fully shut, or fully wide open. Aiming for exact degrees of openness between those two states is difficult because the rate of travel of the windowpane is relatively fast. This is even more pronounced for mowers having an electric motor gate control, which tend to lack a reduction gear found in electric window systems and have a shorter distance of travel. Manually stopping the degree of openness (state) of a discharge gate of an electric motor-controlled discharge gate at a pre-determined or repeatable ‘state’ is rife with error.

In other words, relative to electric motor discharge gate control known to date, fine control is lost due to the speed of gate travel and lack of fineness with the control. Transitioning from fully open to fully closed can occur in a fraction of a second. Stopping the discharge gate precisely at mid-open is dependent on the reflexes of the operator. Fine control is nearly impossible.

What is needed is an improvement over the shortcomings of the prior art.

### SUMMARY

It is an object of the present disclosure to replace an open/off/closed switching control for an electric motor attached to a discharge gate with a microcontroller gauging position sensor and an electronic package. The microcontroller in the electronic package reads a precise position of a user input control (i.e., user selected position) and then sends a signal to a servo motor to move a discharge gate to the user selected position.

In an embodiment, the system provides high and low limit controls so that a user can adjust where the relative open state extremes and relatively closed state extremes be for such user's preferences.

In another embodiment, the system provides a “park” switch. A toggle that will bypass the control and raise the gate into a position out of harm's way if the need arises. When released, the gate will automatically return to the position indicated by the control. The park switch puts the discharge gate in a position (state or attitude) in a relatively safety position, as to be safe from being clipped off by scraping into a mailbox post or the like.

A number of additional features and objects will be apparent in connection with the following discussion of the preferred embodiments.

### BRIEF DESCRIPTION OF THE DRAWINGS

The accompanying drawings form a part of this disclosure and are incorporated into the specification. The drawings illustrate example embodiments of the disclosure and, in conjunction with the description and claims, serve to explain various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein.

FIG. 1 illustrates a plurality of mowers.

FIG. 2 illustrates a prior art electric motor gate control system.

FIG. 3 illustrates a prior art three-position switch.

FIG. 4 illustrates a block diagram of a processor-controlled mower gate assembly.

FIG. 5 illustrates user input controls for a processor-controlled mower gate assembly.

FIG. 6 illustrates a processor-controlled mower gate assembly.

FIG. 7 illustrates adjusting a high gate limit for a processor-controlled mower gate assembly.

FIG. 8 illustrates adjusting a low gate limit for a processor-controlled mower gate assembly.

FIG. 9 illustrates a gate park position for a processor-controlled mower gate assembly.

FIG. 10 shows a flow diagram of an algorithm utilized for a main processing loop of the microprocessor, in a non-limiting embodiment.

FIG. 11 shows a flow diagram of a subroutine utilized for a foot pedal control.

FIG. 12 shows a flow diagram of a subroutine utilized for a joystick control.

FIG. 13 shows a flow diagram of a subroutine utilized for a two-button control.

FIG. 14 shows a flow diagram of a subroutine to determine Park/Work setting based on different user controls.

FIG. 15 shows a diagram of a mower discharge with a discharge gate fully open.

FIG. 16 shows a diagram of a mower discharge with a discharge gate in an intermediate position.

FIG. 17 shows a diagram of a mower discharge with a discharge gate fully closed.

### DETAILED DESCRIPTION

The systems, methods, and devices of the present disclosure each have several aspects, no single one of which is solely responsible for its desirable attributes. Without limiting the scope of this disclosure as expressed by the claims that follow, some features will now be discussed briefly.

The present disclosure is directed to an electronically controlled (i.e., processor or microcontroller controlled) mower gate system for use with various mowers. In an embodiment, the mower gate system may replace a prior art open/off/closed electric motor control with a microcontroller gauging position sensor and electronic package. In other further embodiments, the electronically controlled mower gate assembly or processor-controlled mower gate assembly may replace a manually controlled gate. In other embodiments, the processor-controlled mower gate assembly may be incorporated into Original Equipment Manufacturer (OEM) products. In any embodiment, a microcontroller of an electronics package reads the precise position of a user input control and then sends a signal to a servo motor to move the discharge gate to a corresponding position.

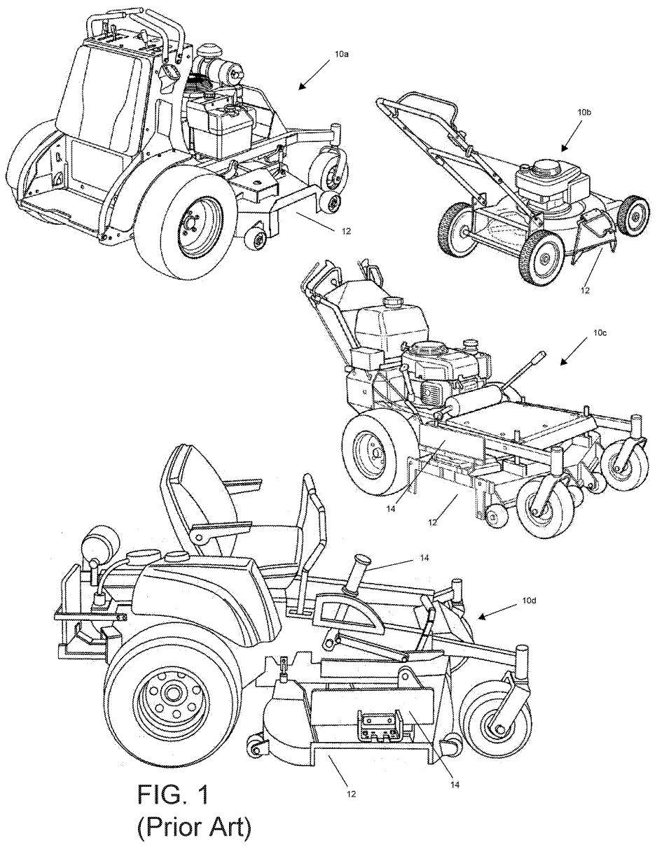

FIG. 1 illustrates a plurality of mowers 10a-10d (hereafter 10, unless specifically referenced). Each of the differently configured mowers 10 includes a discharge opening 12. In various embodiments, the discharge opening 12 of the mowers 10 may be partially or completely covered by a discharge gate 14. The mowers including a discharge gate 14 may control the discharge gate 14 using mechanical levers (e.g., 16 of FIG. 1d) or an electric motor control that allows on/off control for opening and closing the gate 14. Any of the mowers could be adapted to use a processor-controlled mower gate assembly as discussed below.

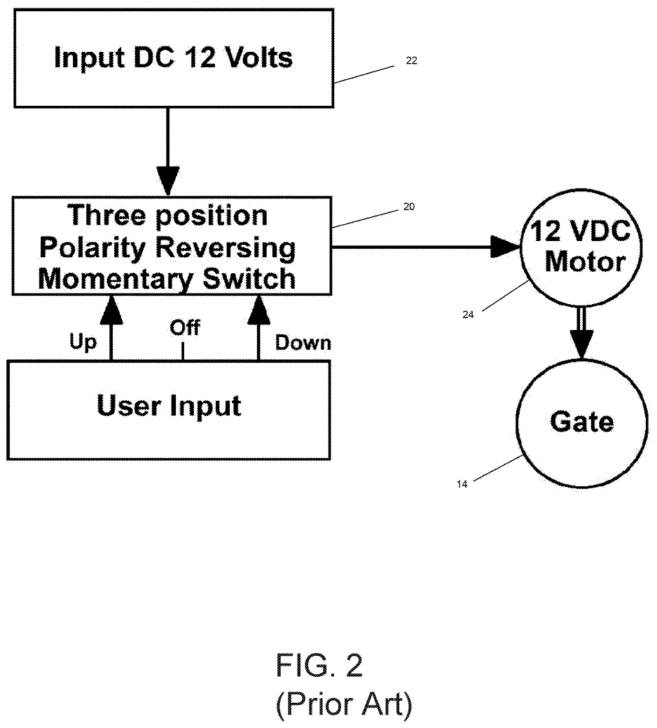

FIG. 2 is a block diagram showing a prior art electric motor discharge gate control system. In operation, a user operates a three-position polarity reversing switch 20 to selectively connect a 12 VDC power source 22 to a 12 VDC motor 24 that moves the gate 14. The DC motor 24 is usually an automotive electric window motor but without the gear train that increases torque while reducing speed. Without the gear train the speed of the gate from fully closed (6 o'clock position) to fully open (12 o'clock position) is very quick, around 0.6 seconds. The working position of the gate (the arc within where the gate is actually in a position to deflect the discharge) is generally between 3 o'clock and 6 o'clock which brings the effective time to control the gate position down to about 0.3 seconds.

The time it takes for an average person to begin moving after a signal depends on the type of stimulus. For instance: visual stimulus: ~250 milliseconds (0.25 seconds): auditory stimulus: ~170 milliseconds (0.17 seconds); and tactile stimulus: ~150 milliseconds (0.15 seconds). Based on tactile reaction time and the short gate movement time (e.g., 0.3 seconds), the average user may only be able to select one or two intermediate positions within the working arc of the gate. One user manual for an electric gate states that a user can change the gate position in increments of roughly 20-degree increments. However, in practice the ability to move the gate in such small increments and the chances of obtaining a repeatable intermediate working position is limited to the user's reaction time.

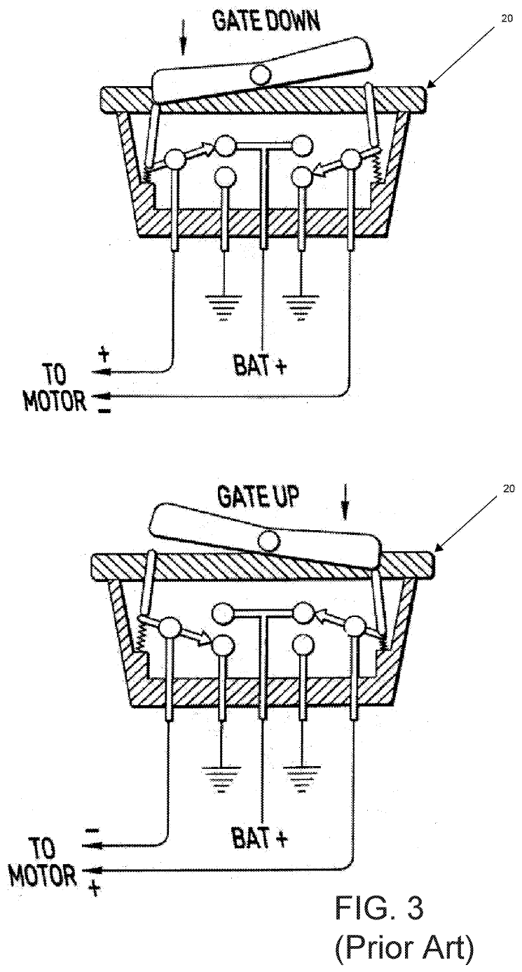

FIG. 3 shows a three-position polarity reversing switch 20 commonly used as a user input for prior electric motor discharge gate control systems. The three-position polarity reversing switch 20, or toggle switch, has the two temporary end or “on” positions and a center “off” position. A user presses either end of the toggle switch, which acts as a double-acting switch, to operate the DC motor (e.g., up or down) and the toggle switch springs back to the center “off” position when released, making it ideal for directional control. As the name implies, the switch reverses polarity of DC current to a DC motor which will then reverse direction depending on which side of the momentary switch is depressed resulting in an up or down action of the gate.

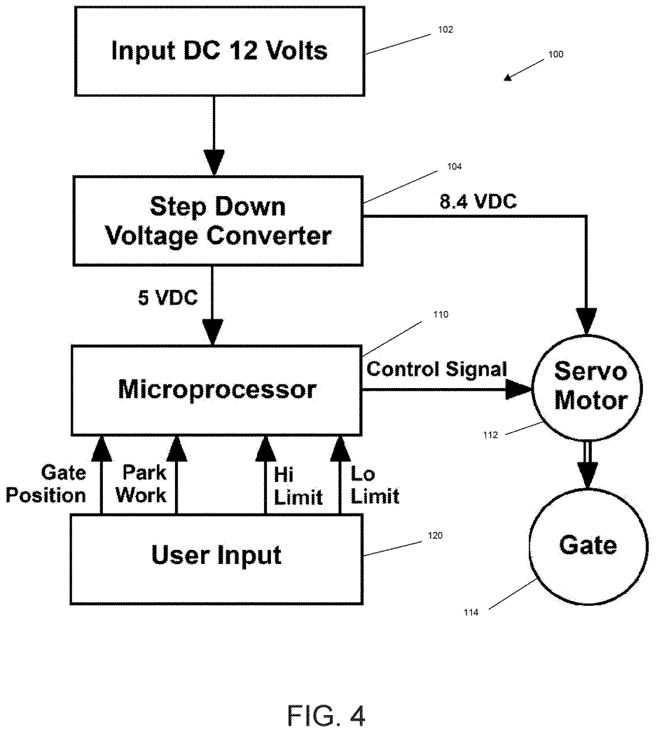

FIG. 4 is a block diagram showing a processor-controlled mower gate assembly 100 in accordance with the present disclosure. As shown, a microprocessor 110 (e.g., microcontroller) is connected to a power source 102 and if necessary, a voltage converter 104. The microprocessor may be a compact microcontroller having a single or multiple-chip computer integrating a processor, memory, and I/O. Alternatively, the microprocessor may be a Programmable Logic Controller that is built specifically for real-time control. In any arrangement, the microprocessor will include memory (e.g., non-volatile memory) for storing programming logic and any conversion tables necessary for mapping user control inputs to motor control signals/outputs, as discussed below. The microprocessor 110 is also connected to a user input 120. The user input 120, in the present embodiment, provides four different input controls to the microprocessor 110. Each of the input controls are related to desired controls (e.g., position controls) for a mower discharge gate 114 attached to a servo motor 112, which is controlled by the microprocessor 110. The user input 120 may allow a user to provide four different control inputs: a high limit, which controls an upper working limit position of the discharge gate 114; a low limit, which controls a lower working limit position of the discharge gate 114; a park/work toggle that defines a “Park” position and “Work” mode for the discharge gate; and a gate position input, which corresponds to a desired gate position when in “Work” mode between the high limit and the low limit. Output signals of the user input controls are read by the microprocessor 110 nearly constantly (e.g., every 0.1 seconds). The microprocessor 110 then interprets the user input controls, generates a discharge gate control signal and sends the discharge gate control signal to the servo motor 112 which moves the discharge gate 114 into the desired position and holds it there until another discharge gate control signal is received.

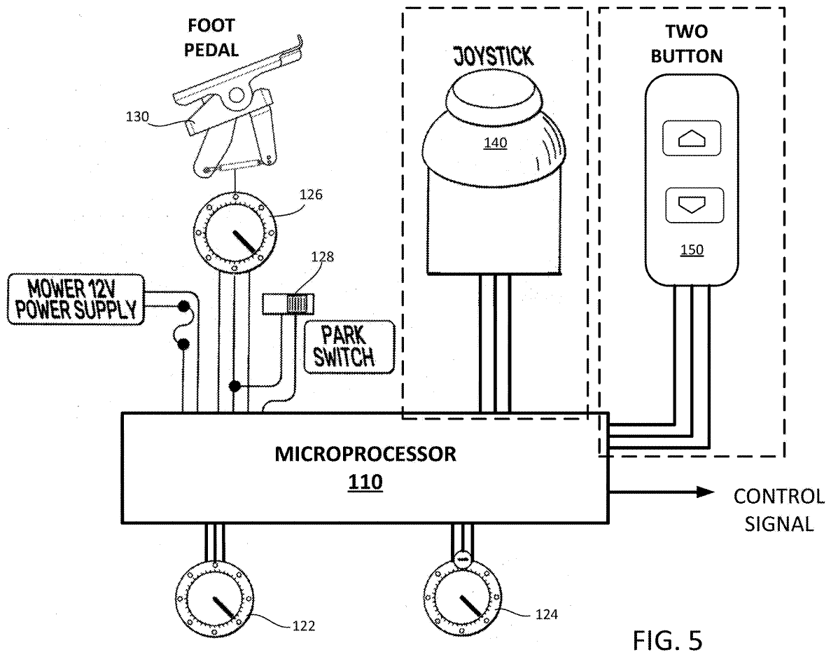

FIG. 5 illustrates four user input controls that may be provided to the microprocessor 110. Generally, the high limit, low limit and discharge gate position input controls are provided by three adjustable position sensors 122, 124 and 126. The adjustable position sensors 122-124 may be any position sensor that generates a position output signal that may be read by the microprocessor 110. In the illustrated embodiment, the position sensors are illustrated as radial potentiometers. However, it will be appreciated that use of radial potentiometers is provided by way of example and not by way of limitation. As shown, a first position sensor 122 may be a first radial potentiometer that allows a user to set the low limit for the discharge gate and a second position sensor 124 may be a second radial potentiometer that allows the user to set the high limit for the discharge gate.

A third position sensor 126 (e.g., user-controlled gate input position sensor), which may be incorporated into a foot pedal 130, allows a user to adjust the position (e.g., target position or target angle) of the discharge gate between the low and high limits established by the first and second position sensors 122, 124. In the illustrated embodiment, a user may rock the foot pedal 130 about a pivot, which may adjust the length of a linear position sensor attached to lower arms below the foot pedal 130. The output value generated by the user-controlled gate position sensor 126 varies based on the position of the foot pedal. The linear position sensor is also illustrated in FIG. 5 as a radial position sensor solely for purposes of illustration. That is, the foot pedal 130 is typically attached to a single position sensor. In any arrangement, the user adjustment of the gate input position sensor 126 generates a position output value, which corresponds to a gate position target angle for the microprocessor 120.

FIG. 5 also illustrates two alternate user inputs that may be used to provide gate position input controls (e.g., target positions) to the microprocessor 110. In an alternate embodiment, a joystick 140 may be used to provide the discharge gate position input. In another alternate embodiment, a two-button controller 150 may be used to provide the discharge gate position input. The joystick and two button control may likewise include user adjustable position sensors that provide gate position inputs to the microprocessor. Other input controls could be utilized, including without limitation, knobs and sliders, which may be attached to, for example, a dashboard or handle of a mower.

FIG. 5 also illustrates a park/work switch 128, which in the illustrated embodiment may be set to an on/parked position or an off/work position. In the park position, the microprocessor may move the discharge gate to a predetermined position and prevent further adjustment using any of the other position sensors 122-126. In the work position, the microprocessor may receive inputs from the position sensors 122-126 and generate control signals for the servo motor 112 connected to the discharge gate 114. See, e.g., FIG. 4. The park switch 128 may be a separate switch or may be built into the user input control in the cases of the joystick and two button control.

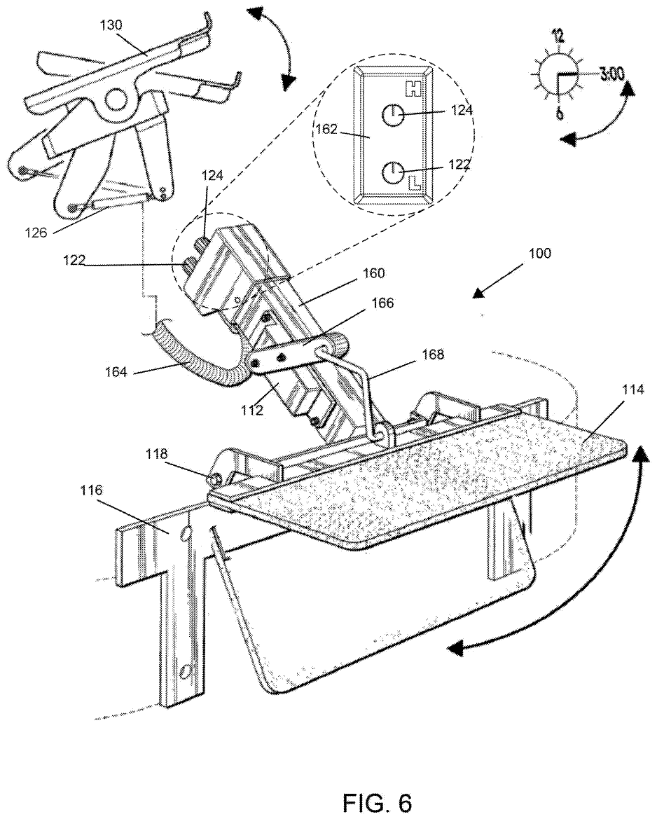

FIG. 6 illustrates one non-limiting embodiment of the processor-controlled mower gate assembly 100 in accordance with the present disclosure. In the exemplary embodiment, a discharge gate 114 is pivotally attached to a frame 116, which may be attached to a discharge opening of various mowers (see, e.g., FIG. 1). It will be appreciated that the gate 114 and the frame 116 may be constructed for application to specific mowers and that the size and exact configuration of these components may vary. In the illustrated embodiment, the discharge gate 114 pivotally connects to the frame 116 via first and second hinge pins 118. This allows the discharge gate to swing relative to the frame 116. In the illustrated embodiment, a masthead structure 160 has a lower end fixedly connected to the frame 116. The masthead structure 160 forms a housing that supports the electronics. (e.g., microprocessor), the servo motor 112 and the first and second position sensors 122 and 124, which control the low limit and high limit, respectively, for the discharge gate 114. The masthead structure 160 extends away from the upper edge of the frame 116 to an upper end. An exploded view of the upper end of the masthead structure 160 is shown to illustrate a face 162 of the masthead. Disposed on the face 162 of the masthead are two knobs which are attached to the first and second position sensors (e.g., radial potentiometers), which allow a user to adjust the high and low gate limits.

The microprocessor (not shown) is disposed within an interior of the masthead structure 160 as is the servo motor 112. The masthead structure 160 includes wiring 164 that allows the microprocessor and servo motor 112 to connect to a power source. In addition, the wiring 164 may also electrically connect the gate position control (e.g., foot pedal 130 as illustrated) to the microprocessor. To move the discharge gate 114, the servo motor 112 is connected to the discharge gate via first and second linkages 166, 168. In the illustrated embodiment, one end of the first linkage 166 is connected to the servo motor 112 and the second end of the first linkage 166 pivotally connects to the first end of the second linkage 168. The second end of the second linkage pivotally connects to the surface of the discharge gate 114. When the servo motor 112 operates (e.g., a shaft of the servo motor rotates), the first linkage 166 rotates about its first end and translates this motion to the second linkage 168 and the discharge gate 114, which pivots relative to the frame 116 about the hinge pins 118. Accordingly, by controlling the movement of the servo motor 112, the position of the discharge gate 114 may be adjusted. Though discussed as including a masthead and linkage to move the discharge gate, it will be appreciated that other configurations are possible and within the scope of the present disclosure. For instance, a shaft of the servo motor may connect directly to the discharge gate in-line with its pivotal connection to the frame.

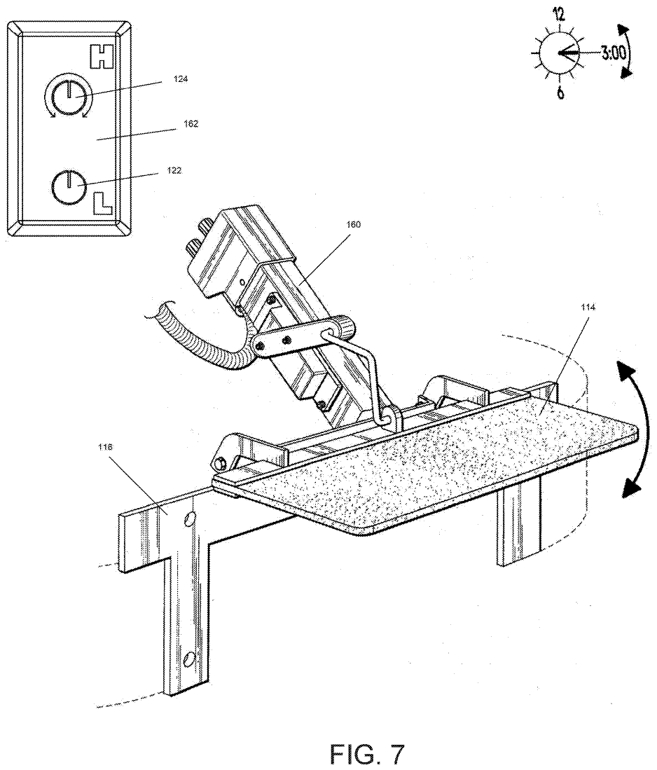

FIG. 7 shows the movement of the discharge gate 114 when the high limit control (e.g., second position sensor 124) is adjusted. The face 162 of the masthead 160 is shown on the upper left and a reference clock face is shown in the upper right as a reference for the actual discharge gate movement. The positions on the clock face show relative reference and not exact movements of the gate. While the high limit control 124 can be adjusted with the discharge gate 114 in any position, the position of the limit can be more accurately determined only when the discharge gate 114 is in the full up position. As the high limit control 124 control is rotated one direction, the upper gate position limit will move higher. This may be desirable on a calm day when grass clipping can be dispersed further. Rotating the high limit control 124 in the other direction will lower the upper gate position limit. This may be desirable on windy days to prevent the wind from catching the grass clipping and blowing them back into the operator's face. Once set, the gate position control will return the gate to the upper limit each time the control is moved to its maximum up position.

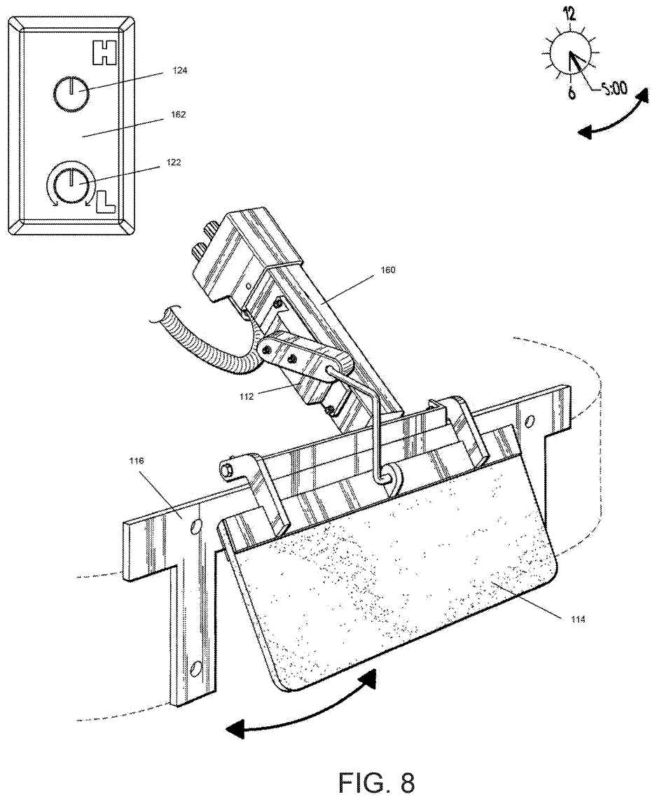

FIG. 8 shows the movement of the discharge gate when the low limit control (e.g., second position sensor 122) is adjusted. The face 162 of the masthead 160 is shown on the upper left and a clock face is shown in the upper right as a reference for the actual gate movement. The positions on the clock face are only meant to be a relative reference and not exact movements of the gate. While the low limit control 122 can be adjusted with the gate in any position, the position of the limit can be more accurately determined only when the gate is in the full down position. As the low limit control 122 is rotated one direction, the lower gate position limit will move higher. This may be desirable when mulching leaves so that the lighter debris does not blow out from under the leading edge of the deck and into the operator's face. Rotating the control 122 in the other direction will lower the lower gate position limit until it contacts the deck itself, fully closing the discharge opening. This closed position may be desirable when people or automobiles pass the discharge side of the mower as a safety precaution or when it is desired to prevent clipping from being blown into landscaping. Once set, the gate position control will return the gate to the lower limit each time the control is moved to its maximum down position.

Referring again to FIG. 6, the movement of the gate is illustrated when the gate position control (e.g., foot pedal 130 as illustrated) is adjusted. This is the most used control by the user allowing for safe change of the discharge gate by either hand or foot control without adversely affecting the user's control of the mower. A clock face is shown in the upper right as a reference for the actual gate movement. The positions on the clock face are only meant to be a relative reference and not exact movements of the gate and will vary depending on where the high and low limits are set (e.g., 3:00 and 6:00 as illustrated). Various means of gate position control are available for the gate position control using a variety of input devices from rotating or sliding/liner potentiometers to momentary switches. Any kind of input device will work so long as the microprocessor can sense the input and the algorithm running on the microprocessor has routines to translate the sensor input into gate movement.

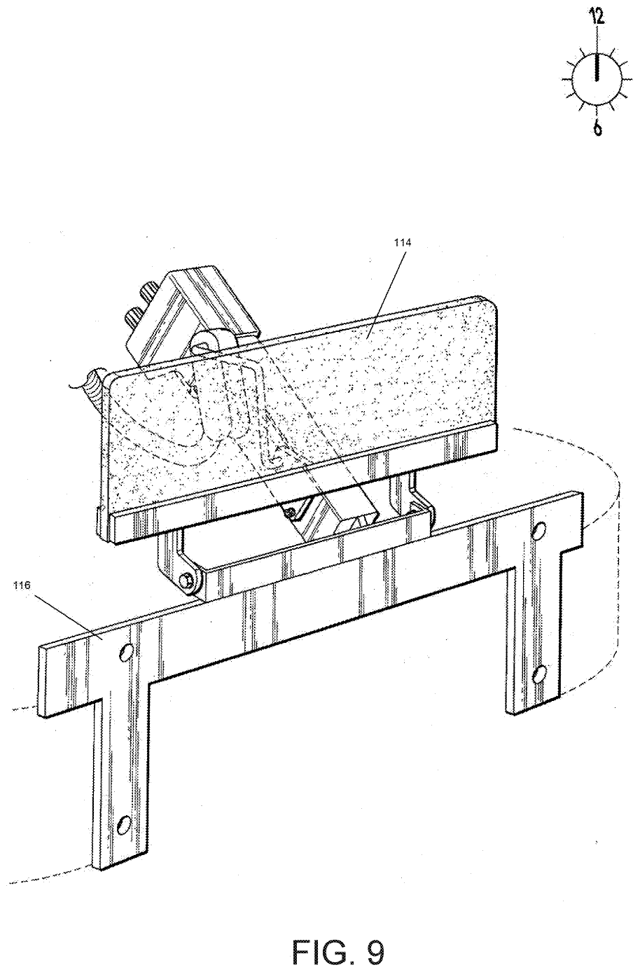

FIG. 9 shows the discharge gate 114 in the “Park” position. The park/work switch 128 (see e.g., FIG. 5) is used to move the gate into a safe position for transportation through narrow gates and other obstacles. When the switch 128 is in the park position, the gate position control is disabled. When the switch 128 is in the working position, the gate position control is active. The gate's working position is stored by the microprocessor when “park” is engaged and the gate is returned to that position when “park” is released. When in “park” position the entire gate only extends out past the original deck less than half an inch making transitions through narrow openings or along low brushy borders safer for the equipment.

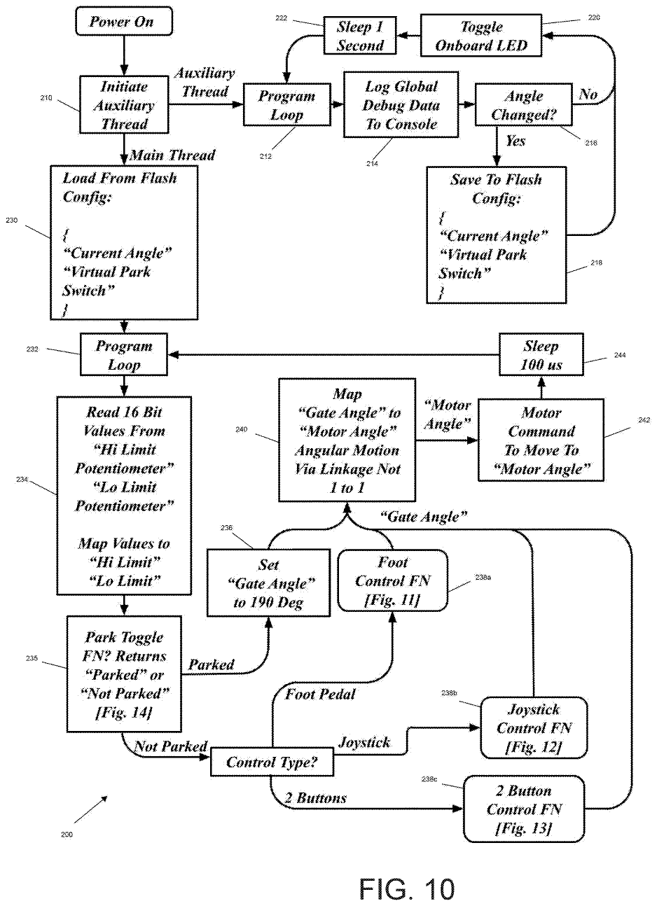

In order to convert the input controls provided by a user to a control signal for a servo motor (e.g., motor control signal) that adjusts the discharge gate to a desired orientation (e.g., target angle), the microprocessor includes various programming logic, which may vary based on the type of user input device providing the target angle input (e.g., foot pedal, joystick, two button control, etc.). FIG. 10 provides a flow diagram of an algorithm 200 utilized for a main processing loop of the microprocessor, in a non-limiting embodiment. When the algorithm is powered on, the microprocessor initiates an auxiliary thread loop 210 and a main thread loop 230. The auxiliary thread loop 210 operates to save the current position/angle and state (e.g., park or work; virtual park switch) of the discharge gate to non-volatile/flash memory such that this information is available to the microprocessor when it is next powered on. The auxiliary thread initiates this program loop 212 and performs various housekeeping functions such as logging global debug data to the console 214, which allows interfacing with an external computer for debugging the gate controller. The auxiliary thread compares 216 a current angle and state of the discharge gate to a prior stored discharge angle and state (e.g., virtual park switch) stored in flash memory. If these values have changed, the new values are saved 216 to memory. Once the values are stored, or if these values have not changed, the auxiliary thread may optionally toggle 220 an onboard LED to indicate that the system is operational. The auxiliary loop then pauses or sleeps for a predetermined time (e.g., 1 second) and then re-runs. This allows for nearly continuous updating of the current gate angle and gate state to non-volatile memory.

Upon initiating the main thread loop 230, the current gate angle and gate state (e.g., virtual park switch) are loaded from the non-volatile/flash memory identifying the starting gate angle and starting state for the program loop 232. Once the main thread program loop 232 is initiated, the microprocessor reads 234 the current positions from the first and second position sensors 122, 124 corresponding to the Hi Limit and Lo Limit values for the discharge gate. In addition, the microprocessor maps values to the Hi limit and Lo Limit.

The microprocessor also reads 235 the state of the park switch/toggle. The process of reading the park switch may depend on the specific type of user input control utilized (e.g. manual toggle, joystick, two button control etc.). If the park switch/toggle is set to park, the microprocessor sets 236 the gate angle to 190 degrees (e.g., ~12 o'clock). If the park switch/toggle is set to work, the microprocessor reads an output of the appropriate discharge gate control input (e.g., foot pedal 238a, joystick 238b or two-button control 238c) to determine a user selected discharge gate angle. The microprocessor then maps 240 the user selected discharge gate angle to a motor angle that will result in generating a servo motor movement that corresponds to the gate angle. As will be appreciated, a rotary movement of the servo motor (e.g., motor angle) may not correspond 1:1 to a user selected gate angle due to, for example, linkages that connect the servo motor to the discharge gate and/or different coordinates of the motor and user input (e.g., rotary vs. linear). By way of example, the servo motor may be limited to a 180-degree range of rotary movement while a linear potentiometer (e.g., gate input position sensor 126; see FIG. 6) for a user control input of a foot pedal may have a range of motion from ‘0’ (fully retracted) to ‘1’ (fully extended). The fully retracted position ‘0’ of the gate input position sensor 126 may be mapped to the 6 o'clock position of the motor angle (see, e.g., FIG. 6), a halfway position ‘0.5’ of the gate input position sensor 126 may be mapped to the 3 o'clock position of the motor angle, and a fully extended position ‘1’ of the position sensor may be mapped to the 12 o'clock position of the motor angle.

The specific mapping relationships between the position sensor 126 of the user control input and the motor angle may depend on the type of position sensor utilized (rotary, linear, etc.) as well as the servo motor and/or linkage between the servo motor and the discharge gate. These mapping relationships may be predetermined and stored to memory associated with the microprocessor.

Once the microprocessor maps 240 the gate angle to the motor angle, the microprocessor generates a control signal or motor command 242 that is provided to the servo motor that causes the servo motor to move to the motor angle. The main loop then pauses or sleeps 244 for a predetermined time (e.g., 100 μs) and then re-runs. This allows for nearly continuous updating and adjusting the gate angle and gate state.

In one non-limiting embodiment, a mapping function is implemented by the microprocessor to map position sensor values to gate position values. In one embodiment, the mapping function takes in 5 inputs:
RangeAMinimum—e.g., position sensor minimum
RangeAMaximum—e.g., position sensor maximum
RangeAValue—e.g., position sensor current value
RangeBMinimum—e.g., gate minimum angle
RangeBMaximum—e.g., gate maximum angle
   The mapping function returns:
RangeBValue—e.g., gate angle corresponding to position sensor current value.
   Generally, the minimum and maximum values for the sensors and discharge gate are known values that may be predetermined and stored by the microprocessor for subsequent use. Along these lines, it will be appreciated that these ranges of values may be specific to different sensors and different discharge gates. With these inputs, the mapping function establishes a mathematical relationship between the Range A value(s) (e.g., position sensor value) and Range B value(s) (e.g., gate position or angle). This is similar to using the freezing point and boiling point of water as the min and maximum values to derive the linear relationship between the Fahrenheit and Celsius scales of temperature measurement. The mapping function uses the relationship between Range A to Range B to find out what the equivalent of a Range A unit is in Range B, which once found is returned as Range B Value. Stated otherwise, the mapping function is performing a unit conversion.

As a non-limiting, looking at a unit conversion between a 16 bit signed integer obtained form reading the Hi potentiometer's analog value (e.g., from position sensor 124), e.g. 27594, to a target gate angle. Starting with a range of the valid raw integer values, 0-31767 and the range of valid degrees for the Hi limit range, 70-110 degrees. Once the function determines the unit conversion, it outputs a value of 93 degrees.

Later in the process, the microprocessor uses the mapping function to convert (or map) the two other units (low position sensor 122 and gate position sensor 126). As a final result, the target gate angle input by the user is converted to a control command (e.g., motor angle) to operate the servo motor. In one embodiment, the target gate angle is converted to an integer value ranging from 0-255, which determines the width of a Pulse Width Modulation (PWM) signal sent to the servo motor. The PWM signal moves the servo motor to the motor angle, which moves the discharge gate to the corresponding gate angle selected input by the user so long as the gate angle input is between the high and low limits. Other mapping function may be used.

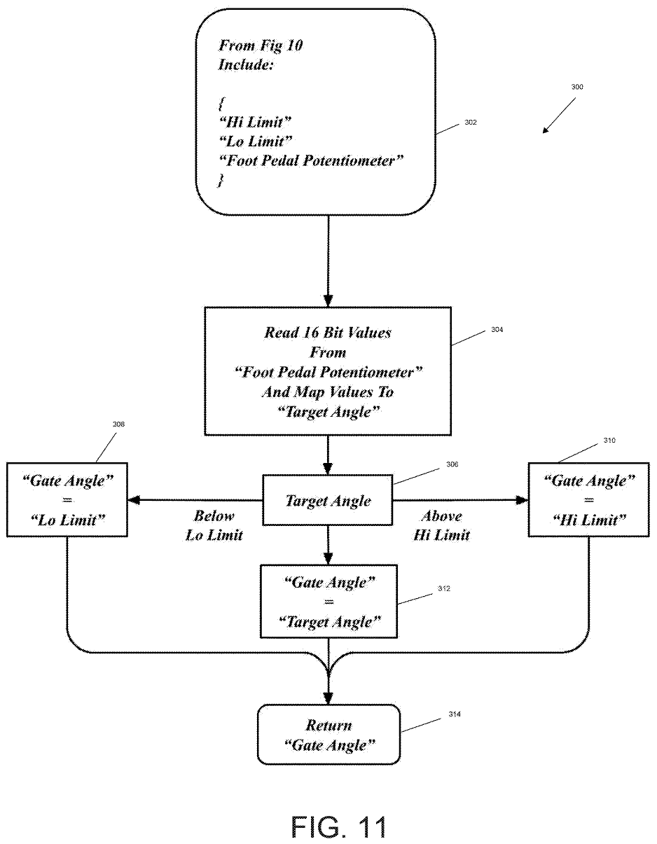

FIG. 11 illustrates a subroutine 300 for reading a foot pedal potentiometer position sensor 126, in an embodiment. The microprocessor starts 302 with the Hi limit and Lo Limit values from the first and second position sensors 122, 124 and a prior output value from the foot pedal potentiometer 126. The microprocessor reads the current output from the foot pedal potentiometer 126 and maps that value to a target angle to generate 306 a current target angle. The microprocessor determines if the target angle is equal to or less than the Lo limit, if so, the microprocessor sets 308 the gate angle to the Lo Limit setting. If not, the microprocessor determines if the target angle is greater than or equal to the Hi limit, if so, the microprocessor sets 310 the gate angle to the Hi limit. If between the Lo Limit and Hi Limit, the microprocessor sets 312 the gate angle to the target angle. In any option, the subroutine returns 314 the gate angle determined from the subroutine to the main program loop of FIG. 10.

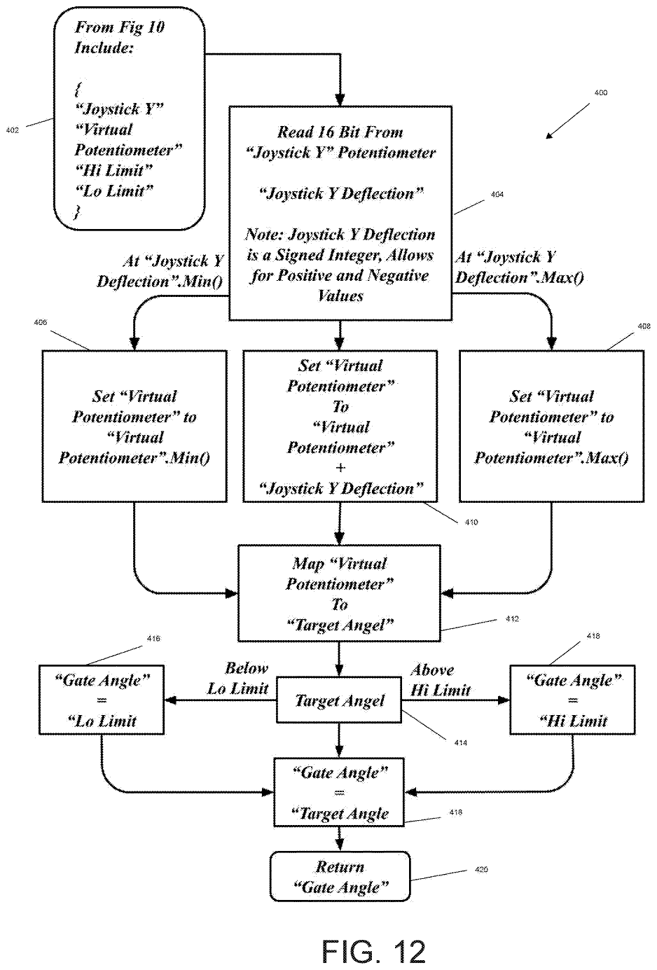

FIG. 12 illustrates a subroutine 400 for reading a two-axis joystick user control input that allows, for example, thumb control of the discharge gate, in an embodiment. The microprocessor starts 402 with the Hi limit and Lo Limit values from the first and second position sensors 122, 124 and a prior ‘Y’ output value (i.e., virtual potentiometer value) from the joystick. The microprocessor reads 404 a current ‘Y’ deflection from the joystick. A determination is made as to if the joystick ‘Y’ position is at a minimum or a maximum. If at a minimum, a virtual potentiometer value is set 406 to a virtual potentiometer minimum value. If at a maximum, a virtual potentiometer value is set 408 to a virtual potentiometer maximum value. If between the minimum and maximum values, the virtual potentiometer setting is set 410 to the prior virtual potentiometer value from step 402 plus the joystick ‘Y’ deflection. In all three cases a virtual potentiometer value is output and mapped 412 to a target angle to generate the target angle 414. The microprocessor determines if the target angle is equal to or less than the Lo limit, if so, the microprocessor sets 416 the gate angle to the Lo Limit setting. If not, the microprocessor determines if the target angle is greater than or equal to the Hi limit. If so, the microprocessor sets 418 the gate angle to the Hi Limit. If between the Lo Limit and Hi Limit, the microprocessor sets 416 the gate angle to the target angle. In any option, the subroutine returns 420 the gate angle to the main program loop of FIG. 10.

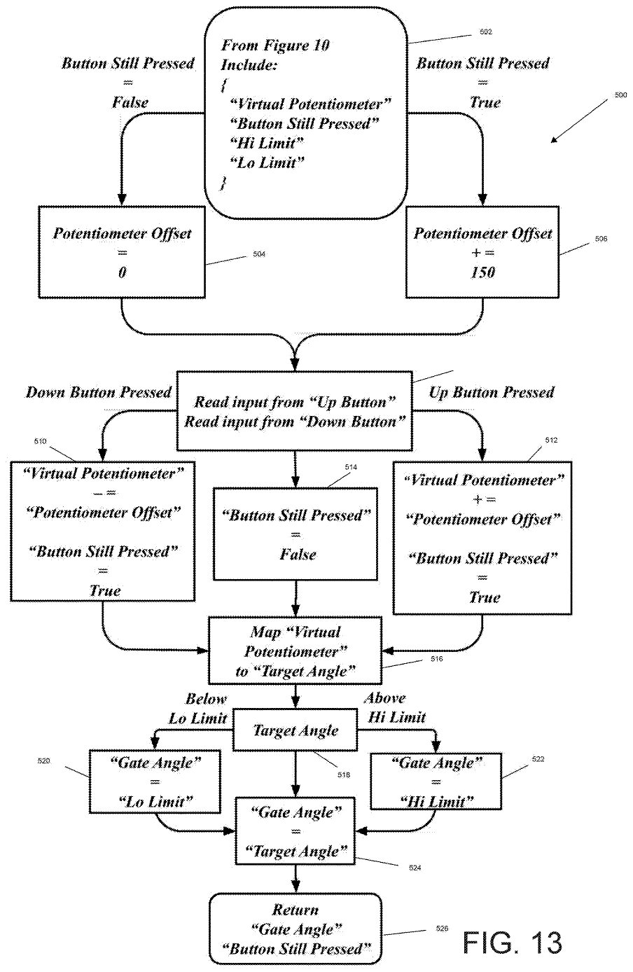

FIG. 13 shows a diagram of a subroutine 500 for a two-button gate position input. Each button works in an individual mode and in a combined mode giving three functional modes. One button controls up movement while the other controls the down. When both are pressed at the same time the “Park/Work” toggle is activated. Short individual presses result in a small movement of the gate, roughly 8 to 10 degrees of movement of the gate per press allowing for 10 to 12 different intermediate positions of the gate between the working extremes of 3 o'clock and 6 o'clock. A long press of either button will result in a fast movement of the gate to the limit of travel in that direction as set by the Hi Limit Control or the Lo Limit Control. The maximum time for full movement from fully closed limit to the full working open limit (or the reverse) is 0.4 seconds with no functional restriction in either direction. Initially, the subroutine starts 502 with the Hi limit and Lo Limit values from the first and second position sensors 122, 124 and virtual potentiometer value (from the buttons on the control) and determines if a control button is still being pushed. If a button is not being pushed, the potentiometer offset is set 504 to zero. If a button is pushed, the potentiometer offset is increased 506 a predetermined amount. The microprocessor then reads 508 inputs from the up and down buttons. If the down button is pushed, the virtual potentiometer value is decreased 510 a predetermined amount. If the up button is pushed, the virtual potentiometer value is increased 512 a predetermined amount. If the buttons are not being pushed, a null adjustment is made to the virtual potentiometer value. In any of these steps 510, 512, 514, the virtual potentiometer value is output and mapped 516 to a target angle to generate the target angle 518. The microprocessor determines if the target angle is equal to or less than the Lo limit, if so, the microprocessor sets 520 the gate angle to the Lo Limit setting. If not, the microprocessor determines if the target angle is greater than or equal to the Hi limit. If so, the microprocessor sets 522 the gate angle to the Hi Limit. If between the Lo Limit and Hi Limit, the microprocessor sets 524 the gate angle to the target angle. In any option, the subroutine returns 526 the gate angle to the main program loop of FIG. 10.

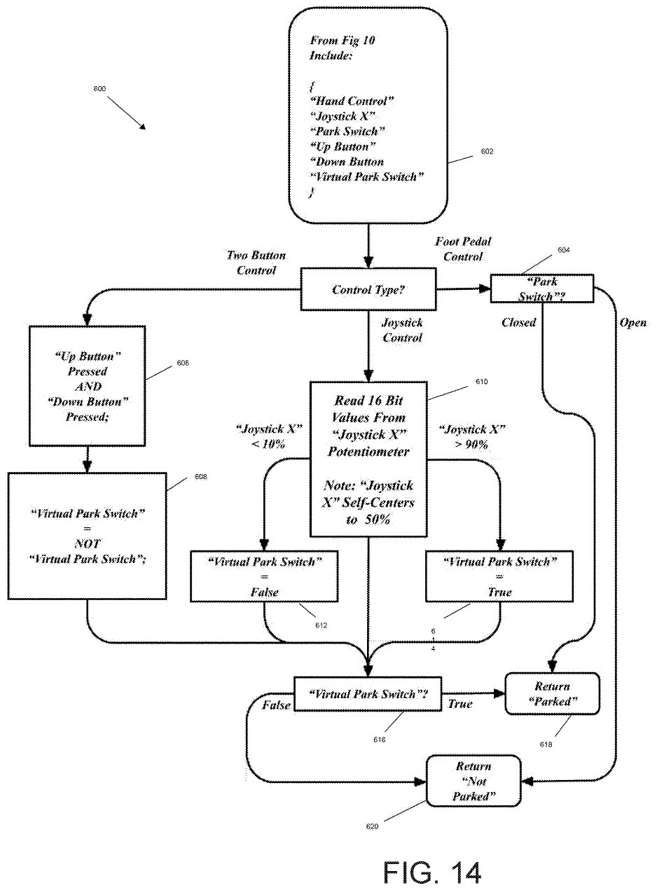

FIG. 14 shows a diagram of a subroutine 600 for determining if the park/work function is on or off. Initially, the subroutine starts 602 with the appropriate inputs depending on the control type. For a foot pedal control using a separate toggle switch, the microprocessor reads 604 the park switch. If closed, the subroutine returns 618 “parked”. If open, the subroutine returns 620 “not parked”. For the two-button control, the microprocessor determines if the up and down buttons are being simultaneously pressed. If so, the state of a virtual park switch is changed from open to closed or closed to open (i.e., true or false). For a joystick control. The microprocessor reads 610 an ‘X’ value for the joystick. If the ‘X’ value is less than a predetermined value, the virtual park switch is set 612 to false. If the ‘X’ value is greater than a predetermined value, the virtual park switch is set 614 to true. Once the virtual park switch is set, the state of the virtual park switch is determined 616. If true, the subroutine returns 618 “parked”. If false, the subroutine returns 620 “not parked”.

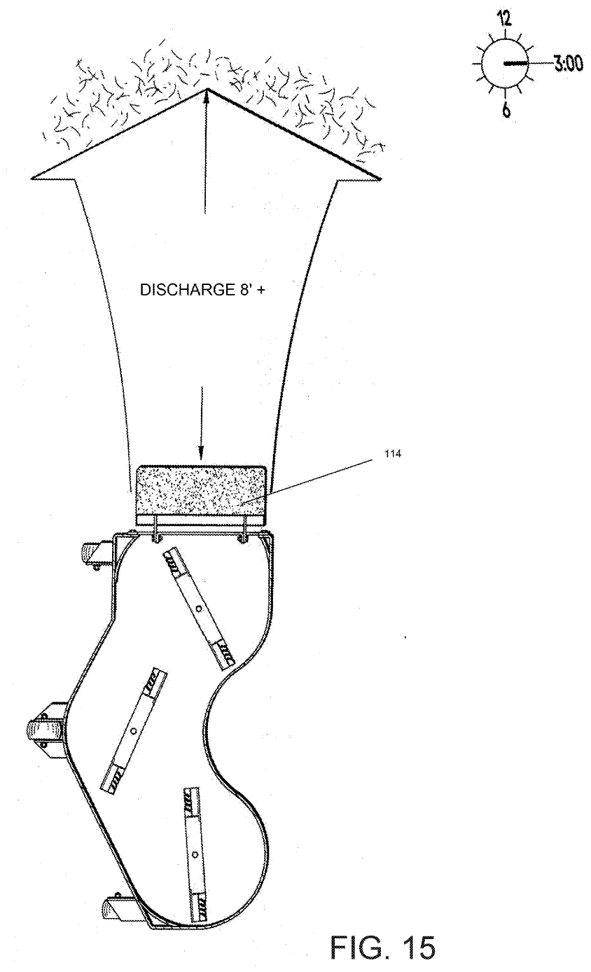

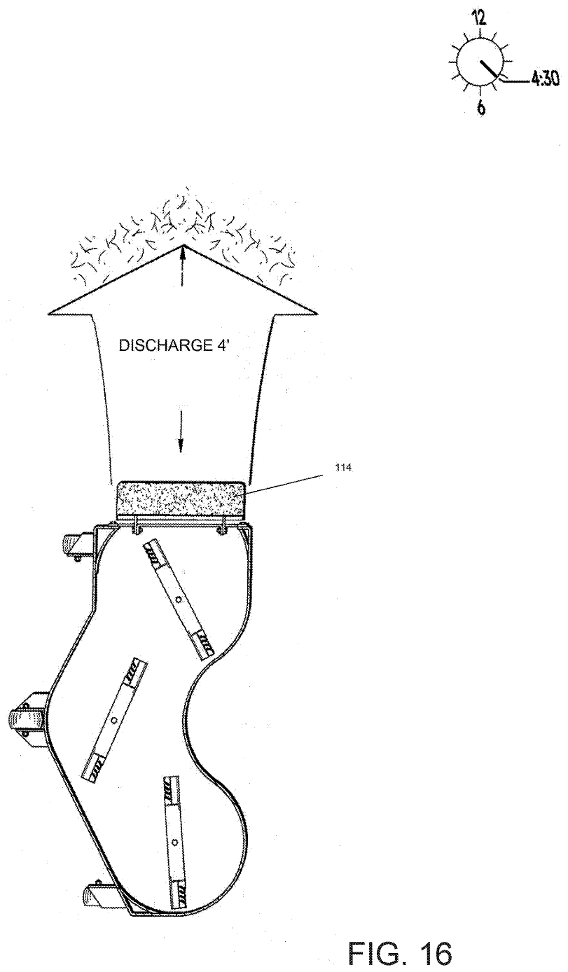

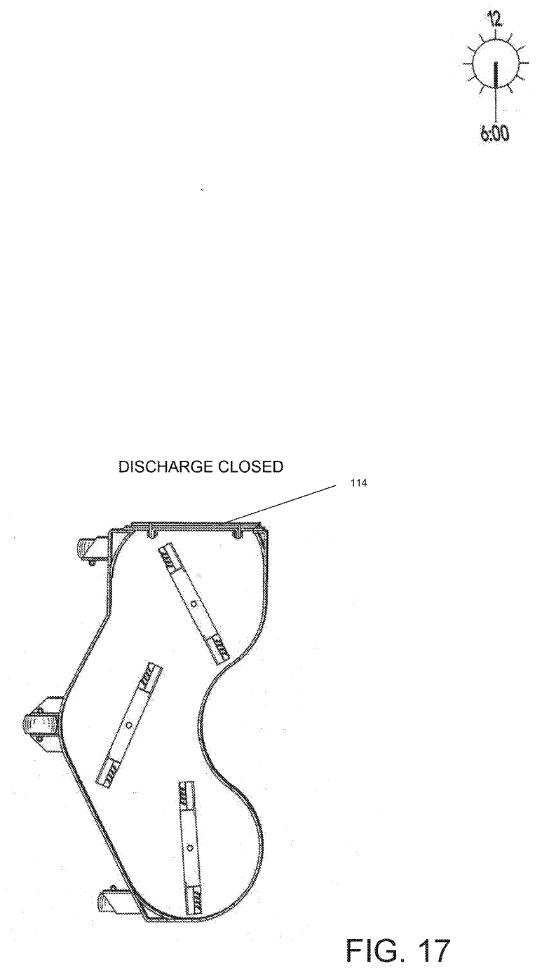

FIG. 15 shows a diagram with the discharge gate in a fully open work position and the resulting spread of grass clippings. The actual distance is dependent on the conditions of the grass (wet or dry), the direction of the wind, and what type of mower blades are being used (normal lift or high lift). This is intended only for relative positions between various positions of the discharge gate 114. FIG. 16 shows a diagram with the discharge gate 114 roughly in a half open work position and the resulting spread of grass clippings as just one example of a wide range of possible intermittent positions. FIG. 17 shows a diagram with the discharge gate in a closed work position with relatively no directional discharge of clipping.

All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrases “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, which is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A mower discharge gate control system, comprising:
an electric motor connected to a mower discharge gate, wherein the electric motor is configured to move the discharge gate through a range of angles between a closed position and an open position;
a user input control having an adjustable gate position sensor for receiving a user selected target angle for the discharge gate and generating a discharge gate target angle value;
a microprocessor operatively connected to the adjustable gate position sensor and the electric motor, the microprocessor configured to:
read the discharge gate target angle value from the adjustable gate position sensor;
convert the discharge gate target angle value to a gate angle value; and
generate a motor control signal to move the discharge gate to a motor angle associated with the gate angle value;
wherein upon receiving the motor control signal from the microprocessor, the electric motor moves the discharge gate to the motor angle.

2. The system of claim 1, wherein the discharge gate target angle value equals the gate angle value.

3. The system of claim 1, wherein the user input control further comprises:
an adjustable high limit gate position sensor for receiving a user selected high limit angle for the discharge gate; and
an adjustable low limit gate position sensor for receiving a user selected low limit angle for the discharge gate.

4. The system of claim 3, wherein the processor is configured to:
compare the discharge gate target angle value with the high limit angle and the low limit angle, wherein the processor sets the gate angle value to the low limit angle if the gate target angle value is less than the low limit angle and sets the gate angle to the high limit angle if the gate target angle value is greater than the high limit angle.

5. The system of claim 3, wherein the processor is configured to:
set the gate angle to the discharge gate target angle value if the discharge gate target angle is between the low limit angle and the high limit angle.

6. The system of claim 1, wherein the user input control further comprises a park-work mode toggle.

7. The system of claim 6, wherein the microprocessor is configured to move the discharge gate to a predetermined angle when the park-work toggle is in a park mode.

8. The system of claim 1, further comprising:
a frame configured for attachment to a discharge opening of a mower, wherein the discharge gate is pivotally connected to the frame.

9. The system of claim 8, wherein the electric motor is fixedly attached to the frame and a rotary output of the electrical motor is connected to the discharge gate.

10. The system of claim 9, wherein the rotary output of the electrical motor is connected to the discharge gate via at least one linkage.

11. The system of claim 9, further comprising a housing attached to the frame, wherein the microprocessor is disposed within the housing.

12. The system of claim 11, wherein at least a portion of the user input control is supported on or within the housing.

13. The system of claim 1, wherein the adjustable gate position sensor comprises one of a linear potentiometer and a rotary potentiometer.

14. The system of claim 1, wherein the adjustable gate position sensor is incorporated with a foot pedal control.

15. The system of claim 1, wherein the adjustable gate position sensor is incorporated with a joystick.

16. The system of claim 1, wherein the adjustable gate position sensor is incorporated with a two-button control.

17. A method for controlling a mower discharge gate, comprising:
reading discharge gate target angle value from an adjustable gate position sensor configured to receive a user selected target angle for a discharge gate;
converting the discharge gate target angle value to a gate angle value;
mapping the gate angle value to a motor angle to generate a motor control signal;
outputting the motor control signal to an electric motor connected to the discharge gate, wherein upon receiving the motor control signal from the microprocessor, the electric motor moves the discharge gate to the motor angle corresponding to the gate angle value.

18. The method of claim 17, further comprising:
receiving a user selected high limit discharge gate angle from an adjustable high limit gate position sensor; and
receiving a user selected low limit discharge gate angle from an adjustable low limit gate position sensor.

19. The method of claim 18, further comprising:
comparing the discharge gate target angle value with the high limit discharge gate angle and the low limit discharge gate angle, wherein the processor sets the gate angle value to the low limit discharge gate angle if the gate target angle value is less than the low limit discharge gate angle and sets the gate angle to the high limit discharge gate angle if the gate target angle value is greater than the high limit discharge gate angle.

20. The method of claim 19, further comprising:
setting the gate angle to the discharge gate target angle value if the discharge gate target angle is between the low limit discharge gate angle and the high limit discharge gate angle.
